(19) United States
(12) Patent Application Publication
(10) Pub. No.: US 2006/0272177 A1
(43) Pub. Date: Dec. 7, 2006

(54) Clothes dryer sensor compensation system and method

(75) Inventors: Nicolas Pezier, Montreal (CA); Sebastien Beaulac, LaSalle (CA)

Correspondence Address: CRAIG WILSON, 2570 MATHESON BLVD. EAST, SUITE 211, MISSISSAUGA, ON, L4W 4Z3, CA

(73) Assignee: MABE CANADA INC., Burlington, CA (US)

(21) Appl. No.: 11/430,979

(22) Filed: May 10, 2006

(30) Foreign Application Priority Data
May 19, 2005 (CA) 2,507,965

(51) Int. Cl. F26B 3/00; F26B 13/10

(52) U.S. Cl. 34/528; 34/446

(57) ABSTRACT

A clothes drying appliance has a moisture sensor and a signal acceleration processor coupled to receive and monitor a moisture signal from the moisture sensor. The processor determines signal gradients in the moisture signal and detects either minimums or maximums in the moisture signal when a sign change occurs between two successive signal gradients. The processor uses the detected local minimum or maximum information and the gradient preceding the detected local minimum or maximum to extrapolate a predicted moisture signal value for the clothing articles. The generation of the predicted moisture signal compensates for sensor response time.

### FIELD OF THE INVENTION

The present invention relates to an appliance for drying clothing articles, and, more particularly, to a dryer using microprocessor based controls for controlling dryer operation.

### BACKGROUND OF THE INVENTION

It is common practice to detect the moisture level of clothes tumbling in a dryer by the use of moisture sensors located in the dryer drum. A voltage signal from the moisture sensor is used to estimate the moisture content of the articles being dried based on the actual characteristics of the load being dried. The sensors are periodically sampled to provide raw voltage values that are then filtered, or smoothed, and inputted to processor modules that determine when the clothes are dry, near dry, or at a target level of moisture content, and the drying cycle should terminate.

As can be appreciated, the voltage signal from the moisture sensor may be highly variable over time and may not accurately reflect the moisture content of the clothing articles. The articles may from time to time contact the electrodes of the moisture sensor and sometimes not come into contact with the electrodes due to generally random tumbling patterns of the clothes.

Another factor effecting the accuracy of the sensor to detect moisture content is the response time of the sensor to accurately sense the moisture content of the clothing as compared to the relatively short period of time the clothing contacts the sensors. Filtered sampled voltages tend to approximate the moisture level or target voltage level for full loads after the clothing has partially dried; however, during the initial stages of the drying cycle the sampled voltages may not accurately reflect the true moisture content of the clothes due to sensor response time. When the sensor response time is relatively long as compared to the length of time clothing contacts the sensor, the filtered sampled voltages tend not to accurately reflect the actual voltage. This problem is more pronounced for small loads that do not come into contact with the sensor as frequently as large loads. This makes it difficult for a dryer during an automatic drying cycle to accurately predict the time required to dry the clothing.

Another factor affecting the accuracy of the sensor to detect moisture content occurs when clothing articles are not evenly dried. That is some portions of the clothing may be wetter than other portions of the clothing and the wetter portions may not be accurately sensed by the circuit for short contact periods due to response time of the sensors.

Any compensation for the response time of the moisture sensor that provides a voltage reading closer to the actual voltage and moisture content of the clothing would be an improvement allowing for the microprocessor based controls to more accurately predict the drying time required for the drying cycle.

### BRIEF DESCRIPTION OF THE INVENTION

The present invention relates to an appliance for drying clothing articles that comprises a signal acceleration processor coupled to receive and monitor a moisture signal from a moisture sensor. The processor determines gradients in the moisture signal and detects local extrema in the moisture signal when the gradients change sign. By local extrema it is meant one of either local maximums in the moisture signal or local minimums in the moisture signal.

It should be understood that the moisture signal may comprise a voltage signal that is linked to the resistance of the clothes by means of an electronic circuit that can be designed in many ways. In one embodiment of the present invention, the voltage signal is chosen to be proportional to the resistance of the clothes, i.e. the voltage signal has a lower value for clothes that are wet and a higher value for clothes that are dry. In this embodiment, the local extrema utilized are local minimums that occur when the moisture signal gradient changes sign from a negative gradient signal (descending raw voltage signal) to a positive gradient signal (ascending raw voltage signal). In an alternative embodiment of the present invention, the voltage signal is chosen to be inversely proportional to the resistance of the clothes, i.e. the voltage signal has a higher value for clothes that are wetter and a lower value for clothes that are dryer. In this alternative embodiment, the local extrema utilized are local maximums that occur in the moisture signal as the signal gradients change sign from an ascending signal gradient to a descending signal gradient.

The processor uses each detected local extremum and the gradient signal preceding the detected local extremum to determine a predicted moisture signal value for the clothing articles.

By determining the moisture signal gradient and detecting the local extremum, the processor uses this information to predict a moisture signal that compensates for sensor response time. The predicted moisture signal approximates the moisture value for the clothes if the clothes were to remain in contact with the sensor until the sensor signal has stabilized.

The appliance of the present invention may further include a noise-reduction filter coupled to the signal acceleration processor to receive the predicted moisture signal values from the signal acceleration processor and reduce the noise contained therein. This filtering may take many forms and in one embodiment computes a new filtered voltage using a time dependent weighted average of the predicted moisture signal values.

In accordance with the present invention there is provided an appliance for drying clothing articles. The appliance comprises a drum for receiving the clothing articles, a motor for rotating the drum about an axis, a heater for supplying heated air to the drum during a drying cycle, a sensor for providing a moisture signal indicative of the moisture content of the clothing articles, and a signal acceleration processor. The moisture signal comprises a plurality of sensed moisture values. The signal acceleration processor is coupled to receive and monitor the sensed moisture values for determining gradients from the sensed moisture values. The signal acceleration processor detects local extrema in the moisture signal when changes in sign occur between two successive gradients. The signal acceleration processor determines predicted moisture signal values for the clothing articles by extrapolating each of the local extrema utilizing each of the gradients of the moisture signal readings and the sensed moisture value occurring prior to the sign change between two successive gradients.

While gradients are preferably determined between two successive sensed moisture values for a predetermined sampling rate, the signal acceleration processor may be configured to determine gradients between every third, or higher sensed moisture values.

In one embodiment the local extrema comprise local minimums in the moisture signal and the sign change occurring between two successive gradients changes from a negative gradient to a positive gradient.

In another embodiment, the local extrema comprise local maximums in the moisture signal and the sign change occurring between two successive gradients changes from a positive gradient to a negative gradient.

In accordance with the present invention there is provided a method for drying clothing articles in a dryer appliance. The method comprises:

generating a moisture signal indicative of the moisture content of the clothing articles where the generated moisture signal comprises a plurality of sensed moisture values;

determining gradients from the sensed moisture values;

detecting local extrema in the moisture signal when changes in sign occur between two successive gradients; and

determining predicted moisture signal values for the clothing articles by extrapolating each of the local extrema utilizing the gradient of the moisture signal readings and the sensed moisture value occurring prior to the sign change between two successive gradients.

### BRIEF DESCRIPTION OF THE DRAWINGS

For a better understanding of the nature and objects of the present invention reference may be made by way of example to the accompanying diagrammatic drawings.

FIG. 1 is a perspective view of an exemplary clothes dryer that may benefit from the present invention;

FIG. 2 is a block diagram of a controller system used in the present invention;

FIG. 3 is a plot for two load sizes of exemplary raw voltage signals received from the sensor where the sensor voltage is proportional to the resistance of the clothes;

FIG. 4 is an enlarged plot of a portion of one of the raw voltage signals of FIG. 3;

FIG. 5 is an exemplary flow chart for predicting the moisture content in the clothing;

FIG. 6 is a plot for an exemplary raw voltage signal received from the sensor where the sensor voltage is inversely proportional to the resistance of the clothes; and,

FIG. 7 is an enlarged plot of a portion of raw voltage signal of FIG. 6.

### DETAILED DESCRIPTION OF THE INVENTION

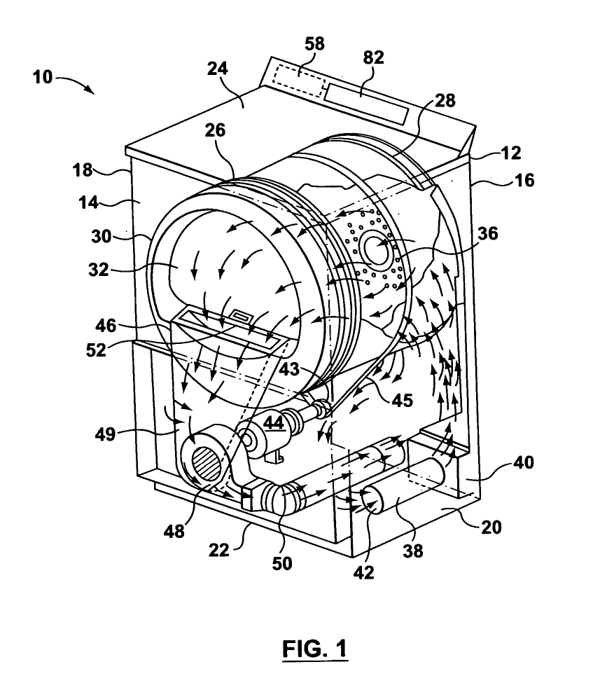

FIG. 1 shows a perspective view of an exemplary clothes dryer 10 that may benefit from the present invention. The clothes dryer includes a cabinet or a main housing 12 having a front panel 14, a rear panel 16, a pair of side panels 18 and 20 spaced apart from each other by the front and rear panels, a bottom panel 22, and a top cover 24. Within the housing 12 is a drum or container 26 mounted for rotation around a substantially horizontal axis. A motor 44 rotates the drum 26 about the horizontal axis through, for example, a pulley 43 and a belt 45. The drum 26 is generally cylindrical in shape, having an imperforate outer cylindrical rear wall 28 and a front flange or wall 30 defining an opening 32 to the drum. The front wall 30 and opening 32 are normally closed by a door (not shown). Clothing articles and other fabrics are loaded into the drum 26 through the opening 32. A plurality of tumbling ribs or baffles (not shown) are provided within the drum 26 to lift the articles and then allow them to tumble back to the bottom of the drum as the drum rotates. The rear wall 28 is rotatably supported within the main housing 12 by a suitable fixed bearing. The rear wall 28 includes a plurality of holes 36 that receive hot air that has been heated by a heater such as a combustion chamber 38 and a rear duct 40. The combustion chamber 38 receives ambient air via an inlet 42. Although the exemplary clothes dryer 10 shown in FIG. 1 is a gas dryer, it could just as well be an electric dryer without the combustion chamber 38 and the rear duct 40. For an electric dryer, electrical heating elements may be located in a heater housing between the rear panel 16 and the rear wall 28. The heated air is drawn from the drum 26 by a blower fan 48 which is also driven by the motor 44. The air passes through a screen filter 46 which traps any lint particles. As the air passes through the screen filter 46, it enters a trap duct 49 and is passed out of the clothes dryer through an exhaust duct 50. After the clothing articles have been dried, they are removed from the drum 26 via the opening 32.

In one the detailed description of this invention, a moisture sensor 52 is used-to predict the percentage of moisture content or degree of dryness of the clothing articles in the container. Moisture sensor 52 typically comprises a pair of spaced-apart rods or electrodes and further comprises circuitry for providing a voltage signal representative of the moisture content of the articles to a controller 58 based on the electrical or ohmic resistance of the articles. The moisture sensor 52 may be located on the front interior wall of the drum. Alternatively, moisture sensor 52 may be located on a rear drum 28 wall for stationary rear drum walls. In some instances the moisture sensor has been used on baffles contained in the dryer drum. By way of example and not of limitation, the sensor signal may be chosen to provide a continuous representation of the moisture content of the articles in a range suitable for processing by controller 58. Typically, this is a range of 1 to 5 volts. The circuitry associated with the sensor 52 (not shown) may be designed to provide a higher voltage reading for wetter clothes than dryer clothes, or alternatively, be designed to provide a lower voltage reading for wetter clothes than dryer clothes.

As the clothes are tumbled in dryer drum 26 they randomly contact the spaced-apart electrodes of stationary moisture sensor 52. Hence, the clothes are intermittently in contact with the sensor electrodes. The duration of contact between the clothes and the sensor electrodes is dependent upon several factors, such as drum rotational speed, the type of clothes, and the amount or volume of clothes in the drum. When wet clothes are in the dryer drum and in contact with the sensor electrodes, the resistance across the sensor 52 is low. Conversely, when the clothes are dry and contacting the sensor electrodes, the resistance across the sensor 52 is high and indicative of a dry load. However, there may be situations that could result in erroneous indications of the actual level of dryness of the articles. For example, in a situation when wet clothes are not contacting the sensor electrodes, the resistance across the sensor is very high (open circuit), which would be falsely-indicative of a dry load. Further, if a conductive portion of dry clothes, such as a metallic button or zipper, contacts the sensor electrodes, the resistance across the sensor 52 would be low, which would be falsely indicative of a wet load. Hence, when the clothes are wet there may be times when the sensor 52 erroneously senses a dry condition (high resistance) and, when the clothes are dry, there may be times when the sensor erroneously senses a wet condition (low resistance). Accordingly, noise-reduction and smoothing is provided by controller 58 that leads to a more accurate and reliable sensing of the actual dryness condition of the articles and this results in more accurate and reliable control of the dryer operation.

The controller 58 is responsive to the voltage signal from moisture sensor 52 and predicts a percentage of moisture content or degree of dryness of the clothing articles in the drum as a function of the resistance of the articles. As suggested above, the value of the voltage signal supplied by moisture sensor 52 is related to the moisture content of the clothes. For example, in the embodiment where the voltage is lower for wetter clothes, at the beginning of the cycle when the clothes are wetter, the voltage from the moisture sensor 52 may range between about one or two volts. As the clothes become dry, the voltage from the moisture sensor 52 may increase to a maximum of about five volts, for example. However, when the clothes touch the rods, the response time associated with the moisture sensor electrodes and circuitry to measure voltage drop across the electrodes may be greater than the contact duration of the clothes with the electrodes. Thus when the clothes contact the electrodes and the voltage across the electrodes drops towards a minimum value representative of the moisture content of the clothes, the voltage drop does not reach this minimum value due to the sensor response time. The controller 58 of the present invention compensates for this shortcoming as is described in more detail herein after.

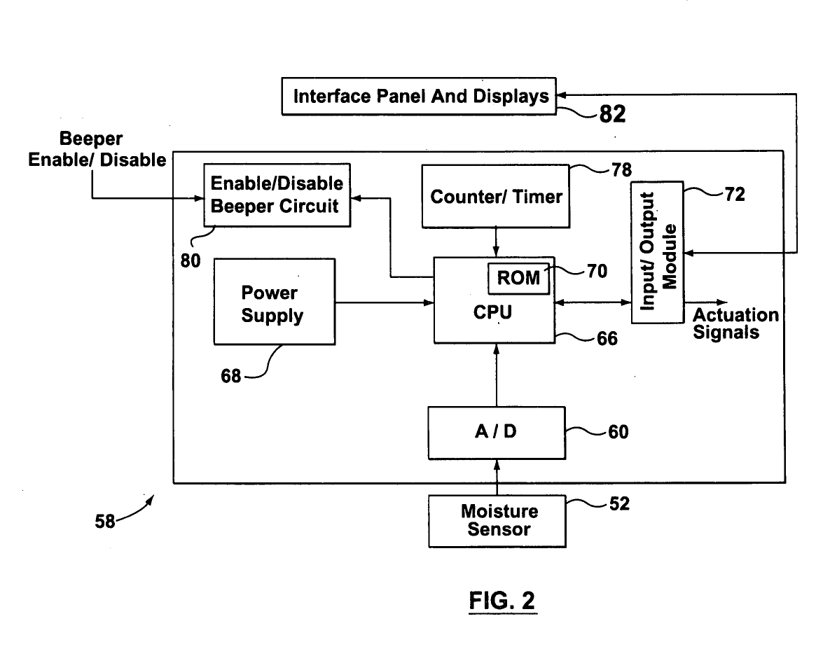

A more detailed view of the controller 58 used in the present invention is shown in FIG. 2. Controller 58 comprises an analog to digital (A/D) converter 60 for receiving the signal representations sent from moisture sensor 52. It should be understood that the signal from sensor 52 is processed through circuitry (not shown). The signal is sampled by A/D converter 60 in accordance with a counter/timer 78 and the sampled values of the moisture signal are sent to a central processing unit (CPU) 66 for further signal processing which is described below in more detail. The CPU which receives power from a power supply 68 comprises one or more processors or processing modules stored in a suitable memory device, such as a read only memory (ROM) 70, for predicting a percentage of moisture content or degree of dryness of the clothing articles in the container as a function of the electrical resistance of the articles. It will be appreciated that the memory device need not be limited to ROM memory being that any memory device that permanently stores instructions and data will work equally effective. Once it has been determined that the clothing articles have reached a desired degree of dryness, then CPU 66 sends respective signals to an input/output module 72 which in turn sends respective signals to deenergize the motor and/or heater. As the drying and cool down cycles are shut off, the controller may activate a beeper via an enable/disable beeper circuit 80 to indicate the end of the cycle to an user. An electronic interface and display panel 82 allows the user for programming operation of the dryer and further allows for monitoring progress of respective cycles of operation of the dryer.

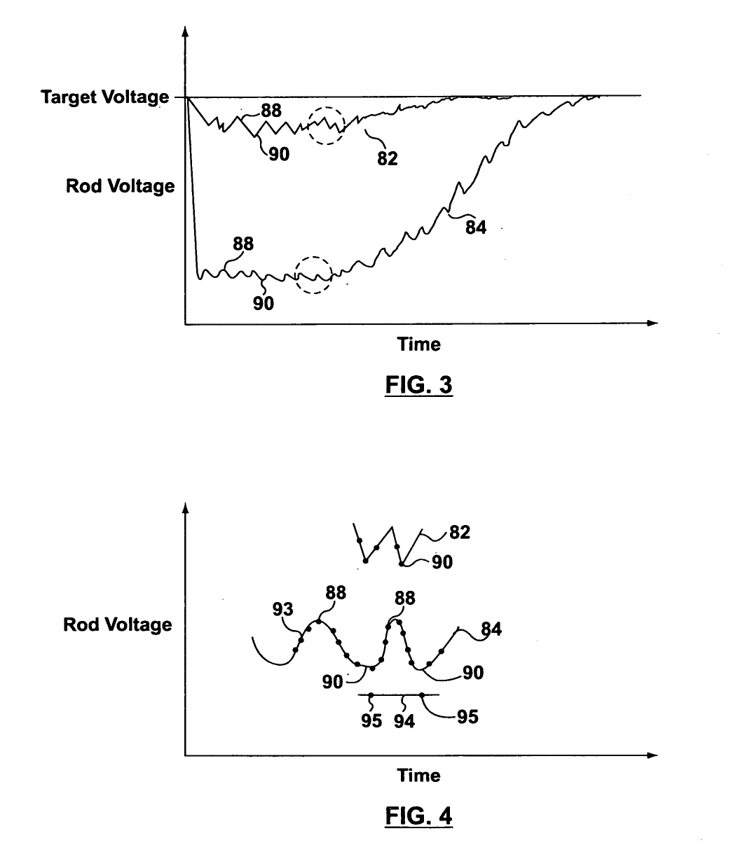

Referring to FIG. 3 there are shown two curves 82 and 84 which are indicative of the raw voltage signal sensed by the moisture sensors or rods 52 during the drying cycle in accordance with an embodiment of the present invention where the raw voltage signal provided by sensor 52 and associated circuitry (not shown) has a lower value for clothes that are wetter and a higher value for clothes that are dryer. Curve 82 represents a situation for a curve representative of a small load whereas curve 84 represents a curve that is indicative of a large load. The curve 84 is closer to the actual moisture content of the clothes in the dryer than curve 82 due to the fact that there are more clothes in contact with the sensor rods or electrodes during the drying process. When the clothes touch the sensor electrodes, the resistance between the electrodes decreases and the voltage drops across the sensor electrodes thereby decreases to a lower value that is indicative of the moisture content of the clothing. However if the clothes do not contact the sensor electrodes for a long enough period of time to overcome the time response delay associated with the sensor electrodes, then the signal reading does not reach its steady state value.

From FIGS. 3 and 4 it can be seen that curves 82 and 84 have a series of maximums 88 and minimums 90. For smaller loads, it is noted that the minimums 90 are further from the actual moisture level of the load as compared to the larger loads in curve 84. However, the slope of the curve immediately preceding the minimum 90 for smaller loads is usually steeper than that for heavier loads. Accordingly, the present invention in the embodiment of FIGS. 3 and 4 provides a processor or controller 58 for detecting the minimums 90 of the voltage signal from the sensor electrodes and the gradient immediately before the minimum. The processor utilizes this information to extrapolate predicted moisture signals for each minimum as shown by points 95 forming curve 94 in FIG. 4.

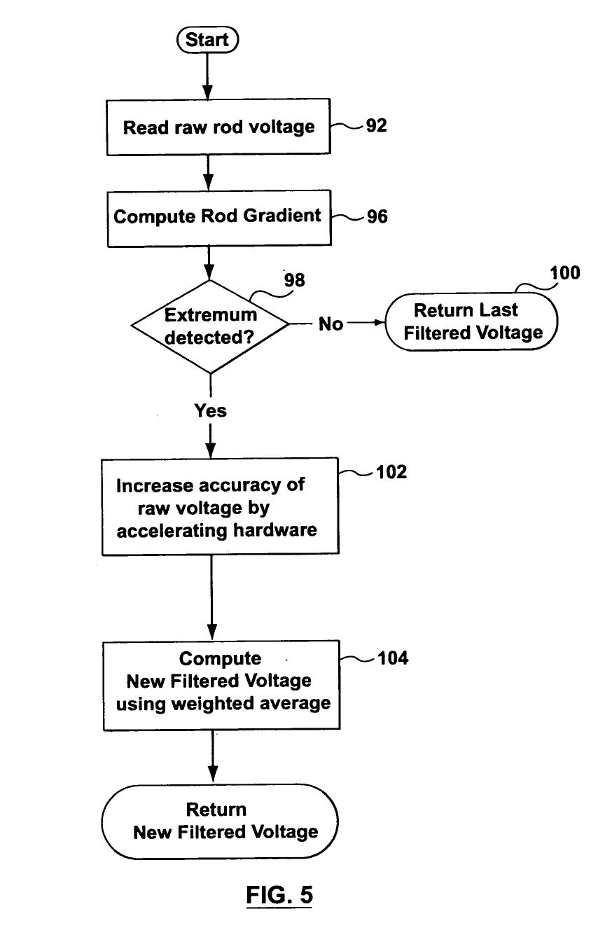

Referring to FIG. 5, the processed flow steps stored within the memory 70 starts with the processor controller 58 reading the raw voltage signal from the sensor electrodes at step 92. This comprises periodic sampling of the raw voltage signal by A/D converter 60 to provide the sampling points 93 shown in FIG. 4. The controller 58 stores the raw voltage sample values, or sensed moisture values, 93 and computes the gradient between the sample values at step 96. When the computed gradients change sign between successive computed gradients from a negative gradient, or descending signal, to a positive gradient, or ascending signal, the controller 58 detects an extremum, or minimum in this embodiment, as shown at decision box 98. When there is no change in sign between successive gradients, no minimum is detected and the controller 58 returns the last filtered voltage at 100 to the computation of the rod gradient value. If the minimum is detected, then the accuracy of the raw voltage sampled value 93 is improved by the accelerating hardware at step 102. The accuracy of the raw voltage sampled value 93 is improved by predicting a voltage value closer to the true moisture value of the clothing articles. This is predicted by taking the last raw voltage sampled value 93 before the changes in sign between successive gradients and extrapolating this value using the formula:
Predicted voltage value=(raw voltage sampled value at extremum×(a+(b×last gradient/(c−last gradient))))/d, (I)

where a, b, c and d are constants. In this embodiment, these constants are chosen as a=8; b=8; c=32 and d=8.

Formula (I) is used to extrapolate the values 95 in curve 94. It should be understood that other formulae may be developed to extrapolate the values and that Formula (I) is a preferred formula. It should also be understood that while the minimum voltages 90 for curve 82 (smaller load). are greater than the minimum voltage 90 for curve 84 (larger load), the gradients in curve 82 are typically steeper than in curve 84 resulting in an associated curve 94. It should be understood that predicted curve 94 is not the same sum for the values of both curves 82 and 84. However, the predicted curve 94 for each of curves 82 and 84 is a more accurate representation of the moisture content of the clothing articles.

Next, the CPU 66 computes at step 104 a new filtered voltage value for the predicted signal voltage using a weighted average formula to reduce the effect of unwanted noise. In the preferred embodiment, the filtered voltage occurs when the number of different minimums detected is greater than 20, since anything prior to this may be considered too soon in the sensing of the raw voltage signal to represent an accurate reading. Further, the filtered voltage using the weighted average at 104 is dependant upon the time between samples or the time between the determination of minimums. The present invention weighs the filtered voltage average in accordance with a weighted average formula:
Filtered voltage=((e−sample count)×last filtered voltage sample+sample count×predicted voltage)/e, (II)

where e is a constant. In this embodiment, e is chosen to equal 1024.

The sample count is used to determine the elapsed time between minimums. When the elapsed time between minimums is too great, stability conditions may need to be considered so as not to place too much weight upon the last filtered voltage sample. It should be understood that other suitable filtering algorithms may be employed to filter out unwanted noise.

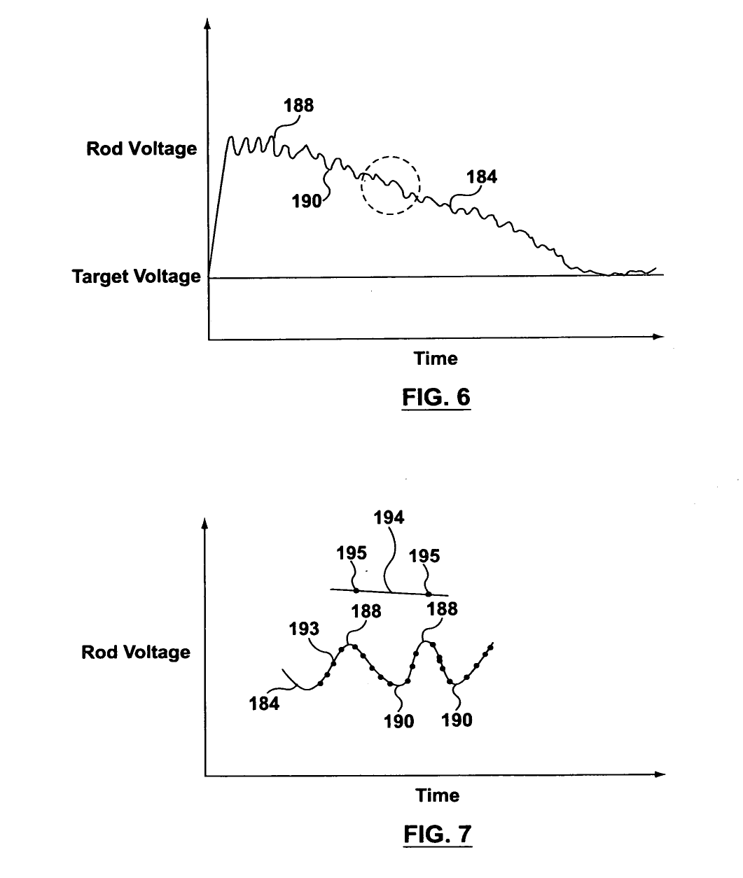

Referring to FIG. 6 there is shown one curve 184 which is also indicative of the raw voltage signal sensed by the moisture sensors or rods 52 during the initial stages or time of the drying cycle in accordance with an alternative embodiment of the present invention where the raw voltage signal provided has a higher value for clothes that are wetter and a lower value for clothes that are dryer. From FIGS. 6 and 7 it can be seen that curve 184 has a series of maximums 188 and minimums 190. The processor or controller 58 for this embodiment, detects the maximums 188 of the voltage signal from the sensor electrodes and the gradient immediately before the maximum. The processor utilizes this information to extrapolate predicted moisture signals for each maximum as shown by points 195 forming curve 194 in FIG. 4.

The extrapolated signal may be processed in the same manner as that described in FIG. 5 for the minimums. Referring to FIG. 5, the processed flow steps stored within the memory 70 starts with the processor controller 58 reading the raw voltage signal from the sensor electrodes at step 92. This comprises periodic sampling of the raw voltage signal by the A/D converter 60 to provide the sampling points, or sensed moisture values, 193 shown in FIG. 7. The controller 58 stores the raw voltage moisture values 193 and computes the gradient occurring between the values 193 at step 96. When there is a change in sign between successive computed gradients from a positive gradient, or ascending signal, to a negative gradient, or descending signal, the controller 58 detects an extremum, or maximum in this embodiment as shown at decision box 98. When no change in sign occurs between successive gradients, no maximum is detected and the controller 58 returns the last filtered voltage moisture value at 100 to the computation of the rod gradient value. If the maximum is detected, then the accuracy of the raw voltage moisture value is improved by the accelerating hardware at step 102. The accuracy of the raw voltage is improved by predicting a voltage value closer to the true moisture value of the clothing articles. This is predicted by taking the last gradient, before the occurrence of a sign change between two successive gradients, the raw voltage moisture value at the extremum, and extrapolating this value using formula (I). Formula (I) is used to extrapolate the values 195 in curve 194.

Next, the CPU 66 computes at step 104 a new filtered voltage value for the predicted signal voltage using a weighted average formula similar to that of Formula (II) to reduce the effect of unwanted noise.

While the invention has been described in terms of various specific embodiments, those skilled in the art will recognize that the invention can be practiced with modifications within the spirit and scope of the present invention as disclosed herein.

What is claimed is:

1. An appliance for drying clothing articles, the appliance comprising:
a drum for receiving the clothing articles;
a motor for rotating the drum about an axis;
a heater for supplying heated air to the drum during a drying cycle;
a sensor for providing a moisture signal indicative of the moisture content of the clothing articles, the moisture signal comprising a plurality of sensed moisture values; and,
a signal acceleration processor coupled to receive and monitor the sensed moisture values for determining gradients from the sensed moisture values, the signal acceleration processor detecting local extrema in the moisture signal when changes in sign occur between two successive gradients; and the signal acceleration processor determining predicted moisture signal values for the clothing articles by extrapolating each of the local extrema utilizing each of the gradients of the moisture signal readings and the sensed moisture value occurring prior to the sign change between two successive gradients.

2. The appliance of claim 1 wherein local extrema comprise local minimums in the moisture signal and the sign change occurring between two successive gradients changes from a negative gradient to a positive gradient.

3. The appliance of claim 1 wherein the local extrema comprise local maximums in the moisture signal and the sign change occurring between the two successive gradients changes from a positive gradient to a negative gradient.

4. The appliance of claim 1 further including a noise-reduction filter coupled to the signal acceleration processor to receive the predicted moisture signal values from the signal acceleration processor and reduce the noise contained therein.

5. The appliance of claim 4 wherein the noise-reduction filter computes a new filtered voltage using a time dependent weighted average of the predicted moisture signal values.

6. The appliance of claim 2 further including a noise-reduction filter coupled to the signal acceleration processor to receive the predicted moisture signal values from the signal acceleration processor and reduce the noise contained therein.

7. The appliance of claim 6 wherein the noise-reduction filter computes a new filtered voltage using a time dependent weighted average of the predicted moisture signal values.

8. The appliance of claim 3 further including a noise-reduction filter coupled to the signal acceleration processor to receive the predicted moisture signal values from the signal acceleration processor and reduce the noise contained therein.

9. The appliance of claim 8 wherein the noise-reduction filter computes a new filtered voltage using a time dependent weighted average of the predicted moisture signal values.

10. A method for drying clothing articles in a dryer appliance, the method comprising:
generating a moisture signal indicative of the moisture content of the clothing articles where the generated moisture signal comprises a plurality of sensed moisture values;
determining gradients from the sensed moisture values;
detecting local extrema in the moisture signal when changes in sign occurs between two successive gradients; and
determining predicted moisture signal values for the clothing articles by extrapolating each of the local extrema utilizing the gradient of the moisture signal readings and the sensed moisture value occurring prior to the sign change between two successive gradients.

11. The appliance of claim 10 wherein the step of determining local extrema comprises determining local minimums in the moisture signal and the sign change occurring between two successive gradients changes from a negative gradient to a positive gradient.

12. The appliance of claim 10 wherein the step of determining local extrema comprises determining local maximums in the moisture signal and the sign change occurring between two successive gradients changes from a positive gradient to a negative gradient.

13. The method of claim 10 further comprising executing a filtering technique on the predicted moisture signal value to reduce the level of noise therein.

14. The method of claim 13 wherein the filtering technique computes a new filtered voltage using a time dependent weighted average of the predicted moisture signal values.

15. The method of claim 11 further comprising executing a filtering technique on the predicted moisture signal value to reduce the level of noise therein.

16. The method of claim 15 wherein the filtering technique computes a new filtered voltage using a time dependent weighted average of the predicted moisture signal values.

17. The method of claim 12 further comprising executing a filtering technique on the predicted moisture signal value to reduce the level of noise therein.

18. The method of claim 17 wherein the filtering technique computes a new filtered voltage using a time dependent weighted average of the predicted moisture signal values.
